(19) United States
(12) Patent Application Publication
(10) Pub. No.: US 2016/0275100 A1
(43) Pub. Date: Sep. 22, 2016

(54) MULTIPLE HIERARCHICAL TREES STORED WITHIN A SINGLE FLAT FILE

(71) Applicant: INFOTRAX SYSTEMS, OREM, UT (US)

(72) Inventors: Larry B. Nash, Provo, UT (US); Mark L. Rawlins, Lehi, UT (US)

(21) Appl. No.: 15/071,071

(22) Filed: Mar. 15, 2016

Related U.S. Application Data
(60) Provisional application No. 62/133,799, filed on Mar. 16, 2015.

(51) Int. Cl. G06F 17/30

(52) U.S. Cl. CPC G06F 17/30221; G06F 17/30091; G06F 17/30327

(57) ABSTRACT

A computerized method for storing multiple, distinct hierarchical data structures within a single ordered flat file. The method can comprise identifying a first hierarchically organized data structure and a second hierarchically organized data structure. The method can also comprise generating an ordered flat file comprising multiple entries—each entry can comprise an addressable location, a first linkage field, and a second linkage field. Further, the method can comprise generating a first ordered flat file representation of the first hierarchically organized data structure and a second ordered flat file representation of the second hierarchically organized data structure within the ordered flat file by determining linear linkages between each of the one or more tree nodes within the respective first hierarchically organized data structure and second hierarchically organized data structure. Individual linkages associated with each respective tree node can be stored within the various respective linkage fields.

### CROSS-REFERENCE TO RELATED APPLICATIONS

This application claims the benefit of and priority to, U.S. Provisional Application Ser. No. 62/133,799, filed on Mar. 16, 2015, entitled “MULTIPLE HIERARCHICAL TREES STORED WITHIN A SINGLE FLAT FILE”. All of the aforementioned applications are incorporated by reference herein in their entirety.

### BACKGROUND OF THE INVENTION

1. Technical Field

The present invention relates generally to the technical characteristics and processing of a digital data structure.

2. Background and Relevant Art

Many businesses store hierarchically organized data in databases where any entry (or row) may be the parent of one or more child entries (or rows) within the database. A typical hierarchically organized database stores data in a relational database table. In some implementations, a particular data set may be associated with multiple different hierarchical trees.

For example, a Multi-Level Marketing company (“MLM”) may utilize a first hierarchically organized data structure that represents an “enrollee tree.” Additionally, an MLM may utilize a second hierarchically organized data structure that represents a “sponsorship tree.” Both the enrollee tree and the sponsorship tree may comprise the same elements, but the elements may be organized in distinctly different hierarchies within the respective trees.

As such, in conventional systems, an MLM may be required to maintain two distinct hierarchical data structures. In large MLM organizations, each of the hierarchical data structures may consume significant storage space. Additionally, when performing calculations on the two hierarchical trees, it may be necessary to load each tree independently into a memory bank of a processing system. One will appreciate that the processor of loading and switching large database files within memory can have a significant impact of processing time.

Accordingly, there are a number of disadvantages with organizational databases that can be addressed.

### BRIEF SUMMARY OF THE INVENTION

The present invention extends to methods, systems, and computer program products for storing hierarchically structured information within an ordered flat file. In particular, implementations of the present invention can store multiple, distinct hierarchical data structures within the same ordered flat file. In at least one implementation, the multiple, distinct hierarchical data structure can comprise the same data and entries—just organized within different hierarchical structures. Additionally, in at least one implementation, calculations based upon any included hierarchical data structure can be performed within the single ordered flat file.

For example, at least one implementation of the present invention comprises a computerized method for storing multiple, distinct hierarchical data structures within a single ordered flat file. For instance, the method can comprise identifying a first hierarchically organized data structure comprising multiple branches, wherein each branch comprises one or more first tree nodes. Additionally, the method can comprise identifying a second hierarchically organized data structure comprising multiple branches, wherein each branch comprises one or more second tree nodes.

The method can also comprise generating an ordered flat file comprising multiple entries—each entry can comprise an addressable location, a first linkage field, and a second linkage field. Further, the method can comprise generating a first ordered flat file representation of the first hierarchically organized data structure within the ordered flat file by determining a first linear linkage between each of the one or more first tree nodes and storing an individual linkage associated with each respective first tree node within each respective first linkage field. Further still, the method can comprise generating a second ordered flat file representation of the second hierarchically organized data structure within the ordered flat file by determining a second linear linkage between each of the one or more second tree nodes and storing an individual linkage associated with each respective second tree node within each respective second linkage fields.

In an additional implementation a computerized method for accessing multiple, distinct hierarchical data structures stored within a single ordered flat file can comprise receiving a query directed towards accessing information associated with a first hierarchically organized data structure. Additionally, the method can comprise accessing a single ordered flat file by identifying a first entry of interest. At least a portion of the entries within the single ordered flat file can comprise both a first linkage field that associates each of the at least a portion of the entries with a position within the first hierarchically organized data structure and a second linkage field that associates each of the at least a portion of the entries with a position within second hierarchically organized data structure. The method can also comprise sequentially accessing entries of interest associated with the first hierarchically organized data structure.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a schematic diagram of an exemplary computer environment in accordance with an implementation of the present invention in which the present invention may be implemented;

FIG. 2 illustrates exemplary hierarchically organized data structure and an exemplary ordered flat file derived from the data;

FIG. 3 illustrates another exemplary hierarchically organized data structure and another exemplary ordered flat file derived from the data;

FIG. 4 illustrates an implementation of an ordered flat file, which comprises multiple hierarchical trees;

FIG. 5 is a flowchart of an exemplary method implemented by one or more embodiments of the invention; and

FIG. 6 is a flowchart of another exemplary method implemented by one or more embodiments of the invention.

### DETAILED DESCRIPTION OF THE PREFERRED EMBODIMENTS

The present invention extends to methods, systems, and computer program products for storing hierarchically structured information within an ordered flat file. In particular, implementations of the present invention can store multiple, distinct hierarchical data structures within the same ordered flat file. In at least one implementation, the multiple, distinct hierarchical data structure can comprise the same data and entries—just organized within different hierarchical structures. Additionally, in at least one implementation, calculations based upon any included hierarchical data structure can be performed within the single ordered flat file.

Accordingly, one or more implementations of the present invention can save significant amounts of memory by storing multiple hierarchically organized data structures within a single ordered flat file. Additionally, in at least one implementation, each of the multiple hierarchically organized data structures can be recreated using the linkage fields stored within the ordered flat file. These and other features may provide significant benefits when attempting to store large data files within limited high-speed memory during processing.

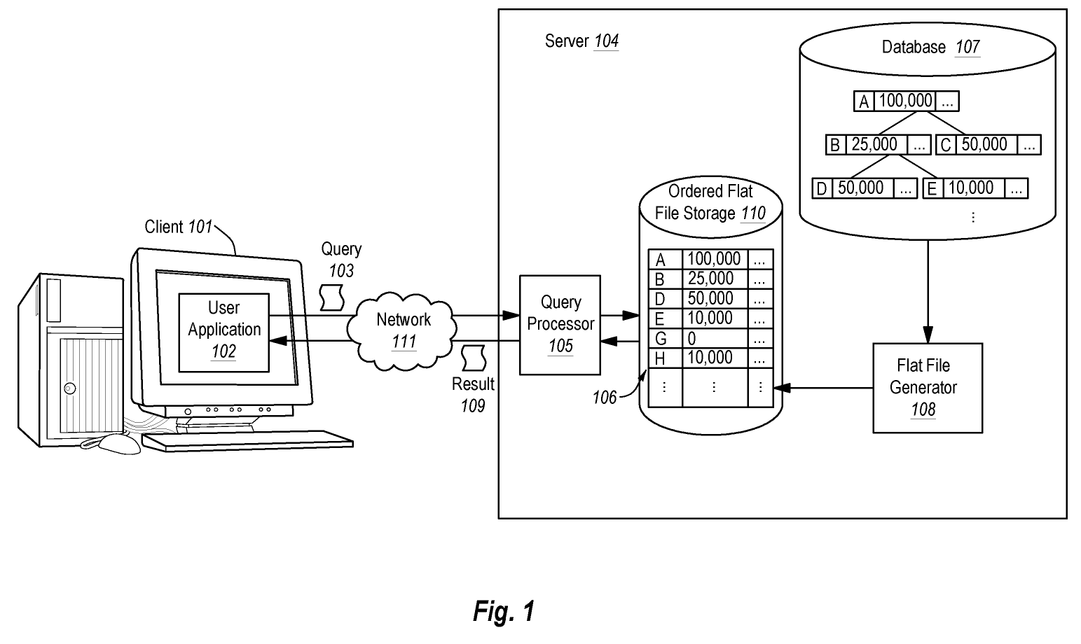

For example, FIG. 1 illustrates a generalized computer environment including a client 101 and a server 104 according to embodiments of the present invention. Client 101 may be any computer including a desktop, laptop, smart phone, etc. In at least one implementation, user application 102 on client 101 can comprise an application that sends queries to a remote computing device over a network 111, such as a server 104, which is configured for processing hierarchical data stored in database 107. User application 102 may be a general-purpose web browser, or may be a dedicated local or web-based application, which sends queries to a remote web server (e.g., server 104).

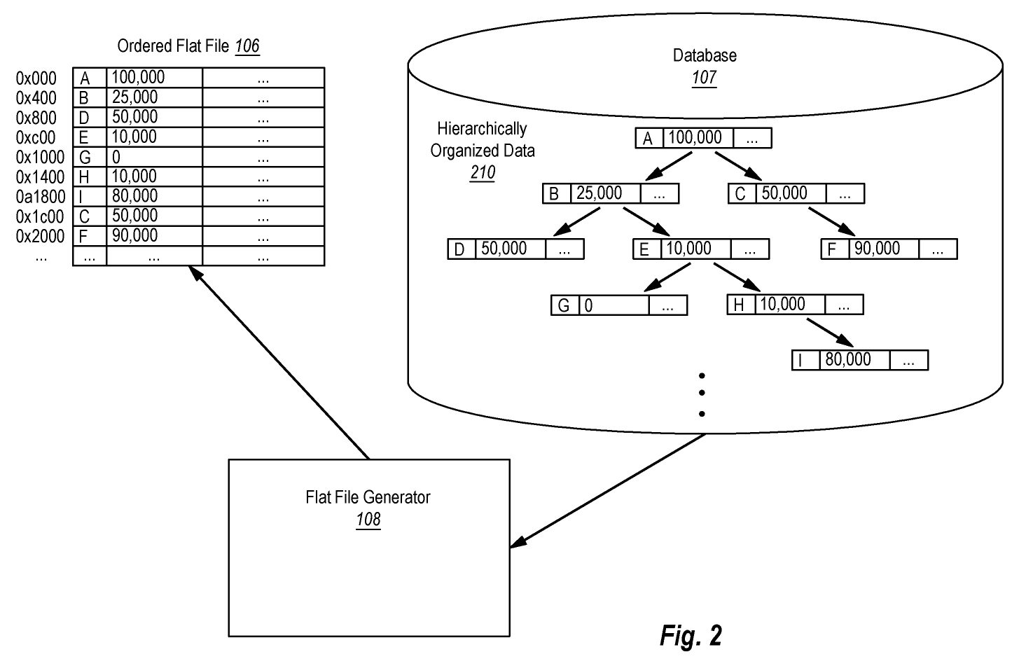

To expedite the processing of such queries, at least one implementation of the present invention can involve use of a flat file generator 108 on server 104 to create and maintain an ordered flat file 106, which can be stored within an ordered flat file storage 110 within the server 104. The ordered flat file storage 110 may comprise high-speed volatile storage, non-volatile hard disk storage, non-volatile flash storage, or any other common storage type. In at least one implementation, the ordered flat file 106 stores at least some of the hierarchical data of the database 107 as a flat file that maintains the hierarchical organization of the data, such as will be further described below with reference to FIG. 2. When the server 104 receives a query from a user application 102, the query processor 105 on server 104 can access the data fields and entries within the ordered flat file 106 to resolve the query rather than accessing the underlying data in database 107. In some implementations, after initially creating the flat file 106, the server 104 can delete the hierarchal data in the database 106.

FIG. 2 depicts an exemplary database 107, which stores exemplary hierarchically organized data 210. In particular, FIG. 2 shows an implementation in which the hierarchically organized data 210 comprises a plurality of elements that each has at least one parent child relationship with another element. FIG. 2 also illustrates an exemplary ordered flat file 206 created from the hierarchically organized data 210 by flat file generator 108. In particular, FIG. 2 shows hierarchically organized data 210 as a tree structure for ease of illustration; however, one will appreciate that an ordered flat file can be created from an underlying database of any type or format (e.g., relational, flat file, etc.). The flat file generator 108 structures the ordered flat file 206 such that all direct descendants of an element are listed directly below the element within the flat file.

For example, because Element A is the base node and all other elements are descendants of Element A, the flat file generator 108 lists Element A first in the ordered flat file. Next, the flat file generator 108 lists Element B with all its direct descendants listed directly below it and prior to any other element that is at the same level or a higher level in the hierarchy than Element B. For example, FIG. 2 shows an implementation in which flat file generator 108 lists Element C (which is at the same level as Element B (i.e., a brother of Element B)) after all of Element B's direct descendants (elements D, E, G, H, and I).

FIG. 2 further depicts an implementation in which the various elements (A, B, D, E, . . . ) are directly adjacent to each other in memory. In at least one implementation, however, the elements are not necessarily next to each other in memory. Instead, in additional or alternative implementations, the various elements can be linked in the same order depicted in the ordered flat file 206 using pointers. For example, Element B can include a pointer to the memory location of Element D and Element A. Accordingly, Element B could identify that Element A is directly above it in the ordered flat file 206 and that Element D is directly below it. Alternatively, in at least one implementation, Element B can include a single pointer to either Element D or Element A, such that the ordered flat file 206 can only be traversed in a single direction.

In this way, any element's descendants can be quickly determined by reading the ordered flat file 206 until an element with the same or higher level in the hierarchy is reached. For example, the query processor 105 can quickly determine that Element I does not have any descendants because the next element below Element I in the ordered flat file 206 is Element C, which is a brother to Element B, and is three levels higher than Element I in the hierarchy.

In at least one implementation, the query processor 105 can determine the level of an element within the hierarchy by accessing a hierarchical level data field (not shown) that comprises information relating to each element's relative level within the hierarchy. Additionally, in at least one implementation, the query processor 105 can determine the level of an element within the hierarchy by identifying each consecutive element's hierarchical parent element. For example, when stepping from Element I to Element C within the order flat file 206, the query processor 105 can identify that Element C's parent element is Element A, and not Element I. As such, the query processor 105 can determine that Element C is the start of a new branch off of Element A.

In this particular example, the listed fields in the ordered flat file 206 of FIG. 2 represent the element's name (or identifier) and a total sales amount for the person represented by the element. However, an ordered flat file can include any number of fields storing any type of data as indicated by the ellipses. For example, each element in the ordered flat file 206 may include a field that defines the element's level in the hierarchy, as well as other fields containing data that may be used to calculate reports.

The ordered flat file 206 of FIG. 2 depicts elements that are 1 KB in size as represented by the hexadecimal addresses to the left of each element. However, the server 104 may allocate any size to elements in the hierarchy. In at least one embodiment, however, the server 104 allocates the same size to each element.

One will appreciate in view of the specification and claims herein that an ordered flat file can be particularly beneficial in representing a “downline” of an individual in a hierarchical organization, such as a multi-level marketing business structure. An individual's “downline” in a multi-level marketing hierarchy refers to the individual and all other individuals that fall below the individual in the hierarchy. Using the example of FIG. 1, Element B's downline would include elements D, E, G, H, and I (but not C, F). Thus, a system can quickly determine B's downline by sequentially reading the ordered flat file from Element B to Element I, and stopping at elements C and F.

Generally, it is faster to access hierarchical data stored in an ordered flat file than it is to access the same data stored in an underlying database. Therefore, calculations based on hierarchical data, such as commissions as previously described, can be performed more quickly by creating an ordered flat file of the hierarchical data, and accessing the hierarchical data within the ordered flat file to generate the required result set.

The flat file generator 108 may create an ordered flat file from a hierarchical dataset stored in an underlying database at various times. For example, a multi-level marketing business may update its database with sales figures at the end of each business day. After the updates are entered each day, the system may generate a complete ordered flat file to represent the state of the hierarchical data after the updates. Of course, an ordered flat file may be created at any interval. Additionally, in at least one embodiment, the system can update an existing flat file to reflect new information by individually accessing and updating each required data field. For example, the system can add a new element to an ordered flat file 206 by updating one or more pointers to include the new element at the correct location within the file.

Generally, a query for data of a hierarchical dataset causes the server to request a sub-portion of the hierarchical dataset. One example includes a query for an individual's downline. As described above, the query processor 105 can obtain the sub-portion of hierarchical data by reading a sequential portion of the ordered flat. To locate the beginning of the sequential portion to be read, the query processor 105 can identify an initial, or starting, element. For example, to locate the beginning of Element B's downline, the query processor 105 will need to identify element B in the ordered flat file.

At least two approaches can be taken to locate the beginning of the sequential portion: “sequential access,” and “random access.” Sequential access refers to reading from the beginning of the ordered flat file, and continuing to read the elements in the ordered flat file until the first element of the sequential portion is identified. Once the first element is identified, the query processor 105 can any permissions (i.e., filtering conditions) to the elements in the portion as the elements are read.

Random access, on the other hand, refers to reading an element of the ordered flat file without first reading the preceding elements in the ordered flat file. Random access can be accomplished by maintaining a location index for each element in the ordered flat file, reading the element's location within the index, and then accessing the ordered flat file at the address provided by the index. In at least one implementation, the flat file generator 108 can address the index and/or the flat file using a hash map.

In either sequential or random access, once the first element of the sequential portion is identified, the query processor 105 can quickly retrieve the remaining elements of the sequential portion by sequentially reading the ordered flat file until an element that is at the same or higher level in the hierarchy is identified at which point no further reads need to be performed. As each element in the sequential portion is read, the query processor 105 can apply the filtering condition to generate one or more result sets. In other words, the query processor 105 need only perform a single pass of the ordered flat file to identify the relevant portion and to apply the permissions to the portion to generate one or more result sets.

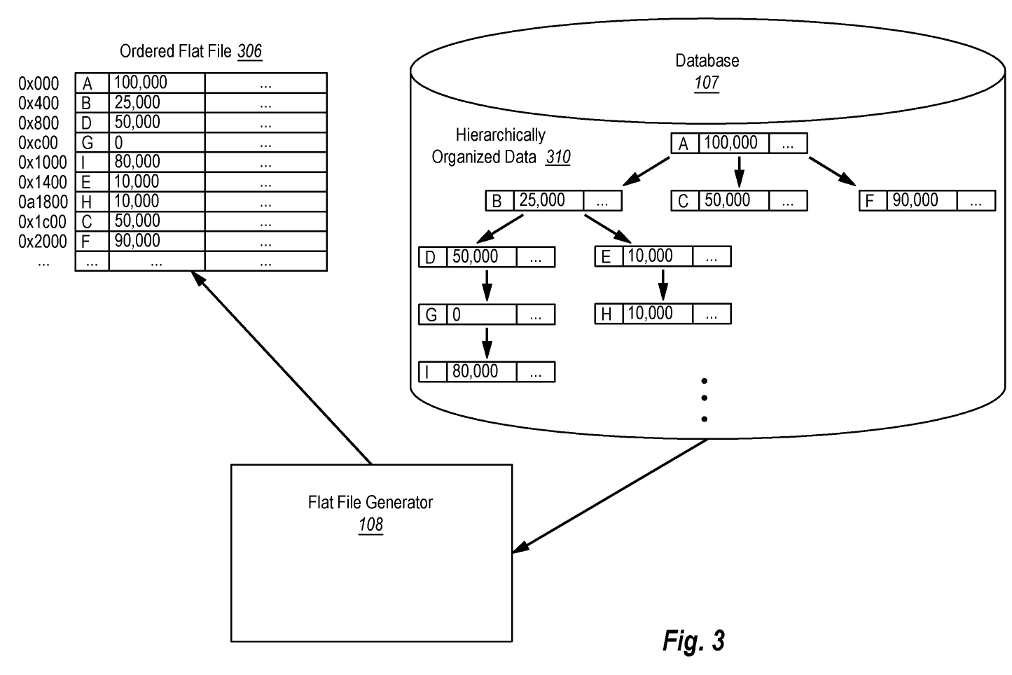

As discussed above, in at least one implementation of the present invention, the flat file generator 108 can store multiple hierarchically organized data structures within a single ordered flat file. For example, FIG. 3 depicts another hierarchically organized data structure 310 within the database 107 of FIG. 1. The hierarchically organized data structure 310 comprises the same entries and data as the hierarchically organized data structure 210 of FIG. 2, but in a different hierarchical order. Because of the different hierarchical order, the ordered flat file 306 also comprises a different order than the ordered flat file 206 of FIG. 2.

Accordingly, the flat file generator 108 can create two different ordered flat files 206, 306 from two different hierarchical data structures 210, 310. In at least one implementation, hierarchically organized data structure 210 may comprise an enrollee data structure that indicates the hierarchy of enrolled members within an MLM structure. In contrast, hierarchically organized data structure 310 may comprise a sponsor data structure that indicates the hierarchy of sponsored members within an MLM structure. As such, the hierarchically organized data structures comprise the same entries and the same data, but comprise a different hierarchical structure. For example, Element F is a child of Element C in hierarchically organized data structure 210, while, in contrast, Element F is a child of Element A in hierarchically organized data structure 310.

In at least one implementation, a user may desire to access information and perform calculations on both hierarchically organized data structure 210 and the hierarchically organized data structure 310. One will understand that each hierarchically organized data structure 210, 310 can comprise hundreds of thousands or millions of entries. As such, storing a unique ordered flat file 206, 306 for each hierarchically organize data structure 210, 310 can consume a significant amount of storage.

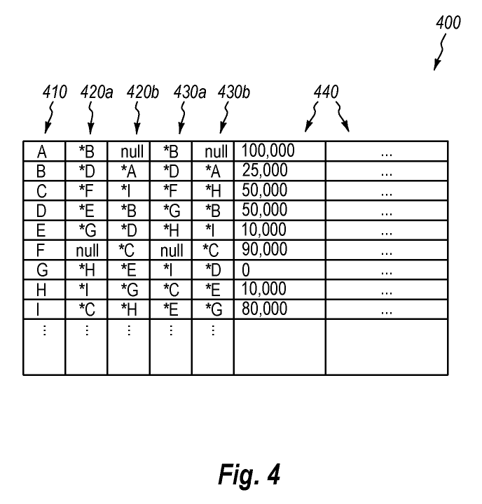

Accordingly, in at least one implementation of the present invention, the flat file generator 108 can store multiple hierarchically organized data structures within a single ordered flat file. For example, FIG. 4 depicts an implementation of a cumulative ordered flat file 400 that comprises the entries and data from both hierarchically organized data structure 210 and hierarchically organize data structure 310, along with information necessary to re-create either respective hierarchically organized data structure 210, 310. Similar to the ordered flat file 210, 310 in FIG. 2 and FIG. 3, only a portion of the cumulative ordered flat file 400 is depicted. As such, the cumulative ordered flat file 400 may comprise additional entries and data fields than those depicted.

The cumulative ordered flat file 400 depicted in FIG. 4 comprises identification column 410 that contains information corresponding to the entry identifications within hierarchically organized data structures 210 and 310. In the depicted cumulative ordered flat file 400, the identification column 410 is in alphabetical order for the sake of ease and clarity. In at least one implementation, the flat file generator can order the various entries in any way within the cumulative ordered flat file 400 without impacting its usefulness. Additionally, in at least one implementation, the entries within the cumulative order flat file may not be sequentially ordered but may instead be spread through a memory space and linked via memory addresses.

The depicted cumulative ordered flat file 400 also comprises the various data fields 440 that were also contained within hierarchically organize data structures 210 and 310. In addition to the information that was contained within the original hierarchically organized data structures 210, 310, the cumulative ordered flat file 400 also comprises linkage fields 420a, 420b, 430a, 430b. As will be described further below, the query processor 105 can use the linkage fields 420a, 420b, 430a, 430b to recreate the original hierarchically organized data structures 210 and 310.

For example, linkage fields 420a and 420b both comprise information related to the hierarchical structure of the hierarchically organized data structure 210. As used within the linkage fields 420a, 420b, 430a, 430b, an asterisk indicates a pointer. For instance, “*B” comprises a pointer that points to the location of Entry B. Accordingly, linkage field 420a comprises a top-to-bottom structure that mirrors the ordered flat file 210 of FIG. 2. Linkage fields 420b, on the other hand, provide a bottom-to-top structure that mirrors the reverse of ordered flat file 210 of FIG. 2.

Each linkage field 420a, 420b, 430a, 430b comprises pointers that link each respective entry to the adjacent entry within the ordered flat file 106, 306. For example, when replicating a top-to-bottom representation of ordered flat file 106 within linkage filed 420a, Element A points to Element B. Element B points to Element D, which points to Element E, and so forth. As such, the order flat file 106 can be recreated top-to-bottom by following the respective pointers within linkage field 420a.

In at least one implementation, a cumulative ordered flat file 400 may comprise only top-to-bottom linkage fields 420a or bottom-to-top linkage fields 420b. One will understand that a query processor 105 using the linkage fields 420a and 420b can traverse the cumulative ordered flat file 400 in a way that recreates the structure of the hierarchically organized data structure 210.

In addition to linkage fields 420a and 420b, the cumulative ordered flat file 400 also comprises linkage fields 430a and 430b. Linkage fields 430a comprise a top-to-bottom structure that mirrors the ordered flat file 310 of FIG. 3. In contrast, linkage fields 430b comprise a bottom-to-top structure that mirrors the reverse of the ordered flat file 310 of FIG. 3. Accordingly, a query processor 105, using the linkage fields 420a and 420b, can traverse the cumulative ordered flat file 400 in a way that recreates the structure of the hierarchically organized data structure 310.

For example, the query processor 105 may receive a query 103 directed towards returning information stored down a particular branch of a hierarchically organized data structure 210, 310. Upon receiving the query 103, the query processor 105 can identify an initial element of interest within the cumulative ordered flat file 400. The query processor 105 can then traverse the particular branch by accessing the pointer information within each successive linkage field 420a, 420b, 430a, 430b within each respective node. This process can continue until the desired information is gathered from the cumulative ordered flat file 400.

Additionally, in at least one implementation, when processing a query 103, the query processor 105 can apply filtering conditions, or permissions, to the query 103. For example, in at least one implementation, a particular user may be restricted from accessing specific elements, specific data fields, or some other portion of the hierarchically stored information. Further, in at least one implementation, different permissions may apply to the different hierarchically organized data structures 210, 310 that are stored within the cumulative ordered data file 400. As such, in at least one implementation, a user may be able to access a particular element or data field when directing a query towards hierarchically organized data structure 210, but be prevented from accessing the same element of data field when directing a query towards hierarchically organized data structure 310, even though the element or data field is stored within the same cumulative ordered flat file 400.

As described above, in addition to the depicted data fields, in at least one implementation, an ordered flat file can also comprise data fields that contain additional information relating to the hierarchical structure that the entry is associated with. For example, an ordered flat file can comprise data fields containing information describing the relative level of the associated entry within the hierarchical data structure, the hierarchical parent of the respective data entry, and other related data. As such, the cumulative ordered data file 400 can comprise similar fields for each respective hierarchically organized data structure. Accordingly, a query processor 105 can identify the relative level of an entry within a hierarchically organized data structure 210, 310 using method similar to those disclosed above.

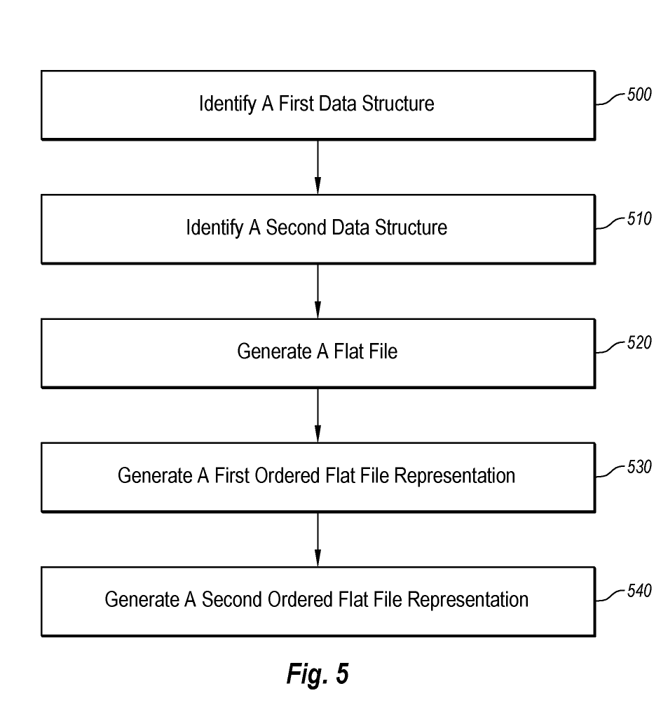

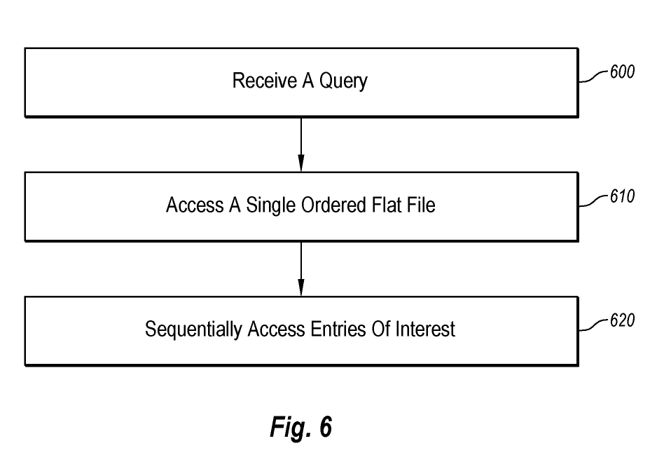

Accordingly, FIGS. 1-4 and the corresponding text illustrate or otherwise describe one or more methods, systems, and/or instructions stored on a storage medium for storing multiple hierarchically organized data structures within a single ordered flat file. One will appreciate that implementations of the present invention can also be described in terms of methods comprising one or more acts for accomplishing a particular result. For example, FIGS. 5 and 6 and the corresponding text illustrate flowcharts of a sequence of acts in a method for storing multiple hierarchically organized data structures within a single ordered flat file. The acts of FIGS. 5 and 6 are described below with reference to the components and modules illustrated in FIGS. 1-4.

For example, FIG. 5 illustrates that a flow chart for an implementation of a method for storing multiple, distinct hierarchical data structures within a single ordered flat file can comprise an act 500 of identifying a first data structure. Act 500 includes identify a first hierarchically organized data structure comprising multiple branches, wherein each branch comprises one or more first tree nodes. For example, in FIG. 2 and the accompanying description, flat file generator 108 receives hierarchically organized data structure 210.

FIG. 5 also shows that the method can comprise an act 510 of identifying a second data structure. Act 501 includes identify a second hierarchically organized data structure comprising multiple branches, wherein each branch comprises one or more second tree nodes. For example, in FIG. 3 and the accompanying description, flat file generator 108 receives hierarchically organized data structure 310.

Additionally, FIG. 5 shows that the method can comprise an act 520 of generating a flat file. Act 520 can include generating an ordered flat file comprising multiple entries, wherein each entry comprises an addressable location, a first linkage field, and a second linkage field. For example, FIG. 4 depicts a generated ordered flat file 400 that includes an addressable location (indicated by the identification column 410), a first linkage filed 420a, and a second linkage field 430a.

Further, FIG. 5 shows that the method can comprise an act 530 of generating a first ordered flat file representation. Act 530 can include generating a first ordered flat file representation of the first hierarchically organized data structure within the ordered flat file by determining a first linear linkage between each of the one or more first tree nodes and storing an individual linkage associated with each respective first tree node within each respective first linkage field. For example, FIG. 2 depicts the flat file generator 108 generating an ordered flat file representation 206 of hierarchically organized data structure 210. The generated ordered flat file representation 206 is then stored within the cumulative ordered flat data file 400 of FIG. 4. As depicted in FIG. 4, each respective node (element) includes accompanying first linkage fields 420a, 420b.

Further still, FIG. 5 shows that the method can comprise an act 540 of generating a second ordered flat file representation. Act 540 can include generating a second ordered flat file representation of the second hierarchically organized data structure within the ordered flat file by determining a second linear linkage between each of the one or more second tree nodes and storing an individual linkage associated with each respective second tree node within each respective second linkage fields. For example, FIG. 3 depicts the flat file generator 108 generating an ordered flat file representation 306 of hierarchically organized data structure 230. The generated ordered flat file representation 306 is then stored within the cumulative ordered flat data file 400 of FIG. 4. As depicted in FIG. 4, each respective node (element) includes accompanying second linkage fields 430a, 430b.

In an additional implementation, FIG. 6 depicts that a method for accessing multiple, distinct hierarchical data structures stored within a single ordered flat file can include an act 600 of receiving a query. Act 600 can include receiving a query directed towards accessing information associated with a first hierarchically organized data structure. For example, FIG. 1 depicts query processor 105 receiving a query 103 that is directed towards information stored within cumulative ordered flat file 400.

Additionally, FIG. 6 illustrates that the method can comprise an act 610 of accessing a single ordered flat file. Act 610 can include accessing a single ordered flat file by identifying a first entry of interest. At least a portion of the entries within the single ordered flat file can comprise both a first linkage field that associates each of the at least a portion of the entries with a position within the first hierarchically organized data structure and a second linkage field that associates each of the at least a portion of the entries with a position within second hierarchically organized data structure. For example, as illustrated and/or described with respect to FIG. 1 and FIG. 4, the query processor 105 accesses cumulative ordered flat file 400.

Further, FIG. 6 shows that the method can comprise an act 620 of sequentially accessing entries of interest. Act 620 can include sequentially accessing entries of interest associated with the first hierarchically organized data structure. For example, in FIG. 4 and the accompanying description, the query processor 105 can sequentially access entries within the cumulative ordered flat file. In at least one implementation, sequentially accessing the entries does not comprise accessing sequential memory spaces, but can instead comprise accessing sequentially linked entries within the cumulative ordered flat file, which may not necessarily be sequential in memory space.

Accordingly, at least one implementation of the present invention provides a method for storing and accessing multiple hierarchically organized data structures within the same ordered flat file. As such, in at least one implementation, the amount of space required to store multiple hierarchically organized data structures can be greatly reduced. Additionally, in at least one implementation, when updating an entry that is common between multiple hierarchically organized data structures, only a single update within an ordered flat file needs to be made—instead of updating multiple hierarchically organized data structures independently.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Embodiments of the present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

Some embodiments, such as a cloud-computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A computer system for storing multiple, distinct hierarchical data structures within a single ordered flat file, comprising:
one or more processors; and
one or more computer-readable media having stored thereon executable instructions that when executed by the one or more processors configure the computer system to perform at least the following:
identify a first hierarchically organized data structure comprising multiple branches, wherein each branch comprises one or more first tree nodes;
identify a second hierarchically organized data structure comprising multiple branches, wherein each branch comprises one or more second tree nodes;
generate an ordered flat file comprising multiple entries, wherein each entry comprises an addressable location, a first linkage field, and a second linkage field;
generate a first ordered flat file representation of the first hierarchically organized data structure within the ordered flat file by determining a first linear linkage between each of the one or more first tree nodes and storing an individual linkage associated with each respective first tree node within each respective first linkage field;
generate a second ordered flat file representation of the second hierarchically organized data structure within the ordered flat file by determining a second linear linkage between each of the one or more second tree nodes and storing an individual linkage associated with each respective second tree node within each respective second linkage field; and
store the ordered flat file, wherein the stored ordered flat file comprises the first linkage field and the second linkage field.

2. The system as recited in claim 1, wherein the ordered flat file comprises the information stored within the first hierarchically organized data structure and the second hierarchically organized data structure, including information associating each entry within the ordered flat file with the entry's relative position within the first hierarchically organized data structure and the second hierarchically organized data structure.

3. The system as recited in claim 1, wherein the information stored within the first linkage fields comprises sufficient information to recreate the first hierarchically organized data structure.

4. The system as recited in claim 1, wherein the information stored within the second linkage fields comprises sufficient information to recreate the second hierarchically organized data structure.

5. The system as recited in claim 1, wherein the first hierarchically organized data structure and the second hierarchically organized data structure comprise the same nodes.

6. The system as recited in claim 5, wherein at least one of the same nodes is located at a first position within the first hierarchically organized data structure and at a second position within the second hierarchically organized data structure, wherein the first position and the second position are not equivalent positions.

7. The system as recited in claim 1, wherein the executable instructions include instructions that when executed configure the computer system to:
receive a query directed towards accessing information associated with the first hierarchically organized data structure;
access the ordered flat file by identifying a first entry of interest; and
sequentially access entries of interest from the first hierarchically organized data structure, wherein sequentially accessing entries of interest from the first hierarchically organized data structure comprises:
accessing a first pointer stored within the first linkage field of the first entry of interest,
accessing another entry of interest associated with the first pointer, and
continuing to access additional entries associated with pointers stored in successive first linkage fields of successive entries.

8. The system as recited in claim 7, wherein the executable instructions include instructions that when executed configure the computer system to:
receive a query directed towards accessing information associated with the second hierarchically organized data structure;
access the ordered flat file by identifying a second entry of interest; and
sequentially access entries of interest from the second hierarchically organized data structure, wherein sequentially accessing entries of interest from the second hierarchically organized data structure comprises:
accessing a second pointer stored within the second linkage field of the second entry of interest,
accessing another entry of interest associated with the second pointer, and
continuing to access additional entries associated with pointers stored in successive second linkage fields of successive entries.

9. The system as recited in claim 8, wherein the first hierarchically organized data structure and the second hierarchically organized data structure comprise different structures.

10. A computer system for accessing multiple, distinct hierarchical data structures stored within a single ordered flat file, comprising:
one or more processors;
one or more computer-readable media having stored thereon executable instructions that when executed by the one or more processors configure the computer system to perform at least the following:
receive a query directed towards accessing information associated with a first hierarchically organized data structure;
access a single ordered flat file by identifying a first entry of interest, wherein at least a portion of the entries within the single ordered flat file comprises both a first linkage field that associates each of the at least a portion of the entries with a position within the first hierarchically organized data structure and a second linkage field that associates each of the at least a portion of the entries with a position within second hierarchically organized data structure; and
sequentially access entries of interest associated with the first hierarchically organized data structure.

11. The system as recited in claim 10, wherein sequentially accessing entries of interest associated with the first hierarchically organized data structure comprises:
accessing a first pointer stored within the first linkage field of the first entry of interest;
accessing another entry of interest associated with the first pointer; and
continuing to access additional entries associated with pointers stored in successive first linkage fields of successive entries.

12. The system as recited in claim 11, wherein the executable instructions include instructions that when executed configure the computer system to:
receive a query directed towards accessing information associated with the second hierarchically organized data structure;
access the single ordered flat file by identifying a second entry of interest; and
sequentially access entries of interest from the second hierarchically organized data structure, wherein sequentially accessing entries of interest from the second hierarchically organized data structure comprises:
accessing a second pointer stored within the second linkage field of the second entry of interest,
accessing another entry of interest associated with the second pointer, and
continuing to access additional entries associated with pointers stored in successive second linkage fields of successive entries.

13. The system as recited in claim 11, wherein the executable instructions include instructions that when executed configure the computer system to:
identify the first hierarchically organized data structure comprising multiple branches, wherein each branch comprises one or more first tree nodes;
identify the second hierarchically organized data structure comprising multiple branches, wherein each branch comprises one or more second tree nodes;
generate the single ordered flat file comprising multiple entries, wherein each entry comprises an addressable location, the first linkage field, and the second linkage field;
generate a first ordered flat file representation of the first hierarchically organized data structure within the single ordered flat file by determining a first linear linkage between each of the one or more first tree nodes and storing an individual linkage associated with each respective first tree node within each respective first linkage field; and
generate a second ordered flat file representation of the second hierarchically organized data structure within the single ordered flat file by determining a second linear linkage between each of the one or more second tree nodes and storing an individual linkage associated with each respective second tree node within each respective second linkage fields.

14. The system as recited in claim 10, wherein the first hierarchically organized data structure and the second hierarchically organized data structure comprise different structures.

15. The system as recited in claim 14, wherein the information stored within the first linkage fields comprises sufficient information to recreate the first hierarchically organized data structure.

16. The system as recited in claim 14, wherein the information stored within the second linkage fields comprises sufficient information to recreate the second hierarchically organized data structure.

17. The system as recited in claim 10, wherein a first filter condition is applied if the query is directed towards the first hierarchically organized data structure.

18. The system as recited in claim 17, wherein a second filter condition is applied if the query is directed towards the second hierarchically organized data structure.

19. The system as recited in claim 18, wherein a particular entry within the ordered flat file is blocked by the first filter and allowed by the second filter.

20. A method, implemented at a computer system that includes one or more processors, for storing multiple, distinct hierarchical data structures within a single ordered flat file, the method comprising:
identifying a first hierarchically organized data structure comprising multiple branches, wherein each branch comprises one or more first tree nodes;
identifying a second hierarchically organized data structure comprising multiple branches, wherein each branch comprises one or more second tree nodes;
generating an ordered flat file comprising multiple entries, wherein each entry comprises an addressable location, a first linkage field, and a second linkage field;
generating a first ordered flat file representation of the first hierarchically organized data structure within the ordered flat file by determining a first linear linkage between each of the one or more first tree nodes and storing an individual linkage associated with each respective first tree node within each respective first linkage field; and
generating a second ordered flat file representation of the second hierarchically organized data structure within the ordered flat file by determining a second linear linkage between each of the one or more second tree nodes and storing an individual linkage associated with each respective second tree node within each respective second linkage field.
